(19) United States
(12) Patent Application Publication
(10) Pub. No.: US 2025/0064005 A1
(43) Pub. Date: Feb. 27, 2025

(54) PLANT CONTAINER DRIPPER DRIP RING, TEE FITTING, AND METHOD

(71) Applicant: Primerus Products, LLC, Encinitas, CA (US)

(72) Inventors: Jack F. Butler, Encinitas, CA (US); Jack F. Butler, JR., Encinitas, CA (US)

(21) Appl. No.: 18/741,448

(22) Filed: Jun. 12, 2024

Related U.S. Application Data
(60) Provisional application No. 63/534,532, filed on Aug. 24, 2023.

(51) Int. Cl. A01G 27/00

(52) U.S. Cl. CPC A01G 27/008

(57) ABSTRACT

A tee fitting for a tubing ring for irrigating a plant in a container, the tubing ring including tubing having a plurality of spaced holes configured to emit water, comprising one or more output ports configured to communicate with the tubing; a supply port configured to communicate with supply tubing, the supply port having an internal diameter configured to determine, for a given water supply pressure, a flow rate of water emitted from the plurality of spaced holes of the tubing.

### CROSS-REFERENCE TO RELATED APPLICATION

This application claims the benefit of U.S. Provisional Patent Application No. 63/534,532, filed Aug. 24, 2023, under 35 U.S.C. 119. U.S. Provisional Patent Application No. 63/534,532 is incorporated by reference herein.

### FIELD OF THE INVENTION

The present invention relates to devices for irrigating plants in containers.

### BACKGROUND

Drip rings have been used by container growers for many years for irrigating plants in pots in commercial nurseries. These drip rings use the following common methods to control flow rate: 1) rings which include holes along their periphery with flow controlling emitters inside the ring at each hole which control flow; flow rate is controlled by multiple devices located at the multiple holes along the periphery; 2) rings which require a separate device (usually a pressure-compensating (“PC”) drip emitter) to regulate the rate of water flow into the supply tubing. A problem with flow controlling emitters used in tubing interiors is that they typically have very low flow rates so the total rate of flow from this type of ring is typically low, on the order of 3 gallons per hour for a 12-inch diameter ring. This flow rate is too low for nursery irrigation applications which typically require flow rates of 10-20 gph per container. Another problem with flow controlling emitters is that because flow rates of these types of flow controlling emitters are very low (typically 0.5 gph per emitter), they are easily clogged by water contaminants. A further problem with flow controlling emitters is that having multiple flow control devices within each ring significantly adds to cost. A problem with PC drip emitters is that they are expensive and operate at flow rates that are lower than most nursery growers require. Another problem is that requiring an external device for flow rate control adds complexity to the system which is a significant drawback when large numbers of rings are installed by unskilled labor.

### SUMMARY

An aspect of the disclosure involves a tubing ring for irrigating plants in containers comprising tubing with a plurality of spaced holes configured to emit water therefrom and a rigid tee fitting including two 180-degree opposed output ports that the tubing is in communication with. The rigid tee fitting includes a supply port having an internal diameter that, for a given supply pressure, determines a flow rate of water emitted from the holes of the tubing and is not materially affected by the diameter of the tubing, the number of holes along its periphery, or other factors. The holes along the tubing ring periphery are sufficiently large that they do not restrict flow, and therefore flow rate is strictly governed by the diameter of a supply port and the pressure applied.

An additional aspect of the disclosure involves a tee fitting for a tubing ring for irrigating a plant in a container, the tubing ring including tubing having a plurality of spaced holes configured to emit water, comprising one or more output ports configured to communicate with the tubing; a supply port configured to communicate with supply tubing, the supply port having an internal diameter configured to determine, for a given water supply pressure, a flow rate of water emitted from the plurality of spaced holes of the tubing.

One or more implementations of the aspect of the disclosure described immediately above includes one or more of the following: the one or more output ports of the tee fitting include two 180-degree opposed output ports; two 180-degree opposed output nipples terminating in the two 180-degree opposed output ports, and the two 180-degree opposed output nipples configured to receive the tubing for communication therewith; a supply nipple terminating in the supply port, and the supply nipple configured to receive the supply tubing for communication therewith to supply water to the ring; the supply port includes an interior with a cross-sectional area; the tubing, which includes an interior with a cross-sectional area, and the cross-sectional area of the interior of the supply port is less than the cross-sectional area of the interior of the tubing; supply tubing in communication with the supply port to supply water to the ring, the supply tubing including an interior with a cross-sectional area, and the cross-sectional area of the interior of the supply port is less than the cross-sectional area of the interior of the supply tubing; the tubing, which includes the plurality of spaced holes having combined cross-sectional areas, and the cross-sectional area of the interior of the supply port is less than the combined cross-sectional areas of the tubing; the tee is rigid and/or flexible; the tubing and the tee and the tubing are a single piece; the tee includes a rigid stake configured to be secured into soil in the container; the tee includes a solid nipple through which water cannot flow, the solid nipple configured to receive supply tubing and function as a temporary holder of the supply tubing while blocking water flow from the supply tubing to the tee fitting; the tee is a member of a kit and/or product line of different flow-rate tees with different supply port interior diameters; the kit and/or product line of different flow-rate tees include different colors with each color signifying a specific flow rate.

Another aspect of the disclosure involves a method of using a tee fitting for a tubing ring for irrigating a plant in a container, the tubing ring including tubing having a plurality of spaced holes configured to emit water, comprising one or more output ports configured to communicate with the tubing; a supply port configured to communicate with supply tubing, the supply port having an internal diameter configured to determine, for a given water supply pressure, a flow rate of water emitted from the plurality of spaced holes of the tubing, the method comprising surrounding the plant of the container with the tubing; attaching the tubing to the one or more output ports of the tee; attaching supply tubing to the supply port of the tee; supplying water to the tubing via the supply tubing and the supply port; emitting water from the tubing to irrigate the plant via the plurality of spaced holes.

One or more implementations of the aspect of the disclosure described immediately above includes one or more of the following: the tee includes a solid nipple through which water cannot flow, the solid nipple configured to receive the supply tubing and function as a temporary holder of the supply tubing while blocking water flow from the supply tubing to the tubing ring, and the method further comprising detaching the supply tubing from the supply port and attaching the supply tubing to the solid nipple so as to temporary hold the supply tubing while blocking water flow from the supply tubing to the tubing ring; the tee is a member of a kit and/or product line of different flow-rate tees with different supply port interior diameters, and the method further comprising surrounding a different plant of a different container with different tubing; attaching the different tubing to the one or more output ports of a different flow-rate tee of the kit and/or product line; attaching different supply tubing to the supply port of the different flow-rate tee; supplying water to the different tubing via the different supply tubing and the supply port of the different flow-rate tee; emitting water from the different tubing at a different flow rate to irrigate the different plant via the plurality of spaced holes of the different tubing; the one or more output ports of the tee fitting include two 180-degree opposed output ports; two 180-degree opposed output nipples terminating in the two 180-degree opposed output ports, and the two 180-degree opposed output nipples configured to receive the tubing for communication therewith; a supply nipple terminating in the supply port, and the supply nipple configured to receive the supply tubing for communication therewith to supply water to the ring; the supply port includes an interior with a cross-sectional area; the tubing, which includes an interior with a cross-sectional area, and the cross-sectional area of the interior of the supply port is less than the cross-sectional area of the interior of the tubing; supply tubing in communication with the supply port to supply water to the ring, the supply tubing including an interior with a cross-sectional area, and the cross-sectional area of the interior of the supply port is less than the cross-sectional area of the interior of the supply tubing; the tubing, which includes the plurality of spaced holes having combined cross-sectional areas, and the cross-sectional area of the interior of the supply port is less than the combined cross-sectional areas of the tubing; the tee is rigid and/or flexible; the tubing and the tee and the tubing are a single piece; the tee includes a rigid stake configured to be secured into soil in the container; and/or the kit and/or product line of different flow-rate tees include different colors with each color signifying a specific flow rate.

### BRIEF DESCRIPTION OF DRAWINGS

The accompanying drawings, which are incorporated in and form a part of this specification illustrate embodiments of the invention and together with the description, serve to explain the principles of the invention.

FIG. 1 is perspective view of an embodiment of a tubing ring for irrigating plants in containers.

FIG. 2 is a perspective view of a rigid tee fitting and tubing of the tubing ring of FIG. 1.

FIG. 3 is an enlarged perspective view of the rigid tee fitting of FIG. 2.

FIG. 4 is a side elevational view of the rigid tee fitting of FIG. 2 and illustrates a long rigid stake attached to the rigid tee fitting.

FIG. 5 is a cross-sectional view of the rigid tee fitting of FIG. 4 taken along line 5-5 of FIG. 4.

### DESCRIPTION OF EMBODIMENT OF THE INVENTION

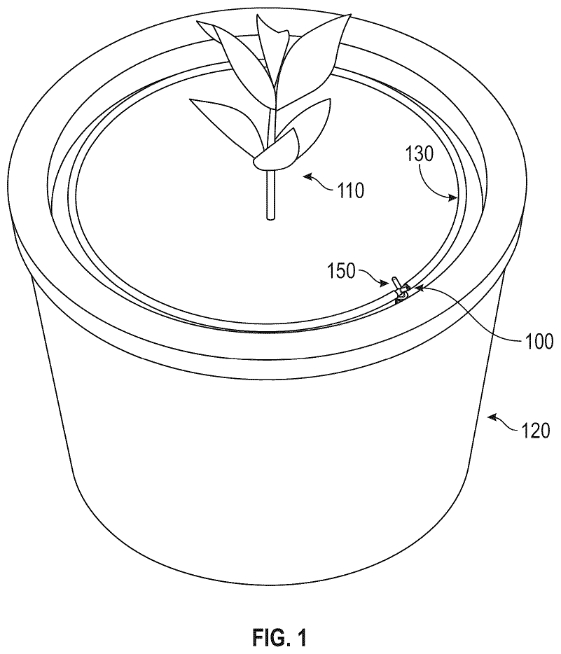

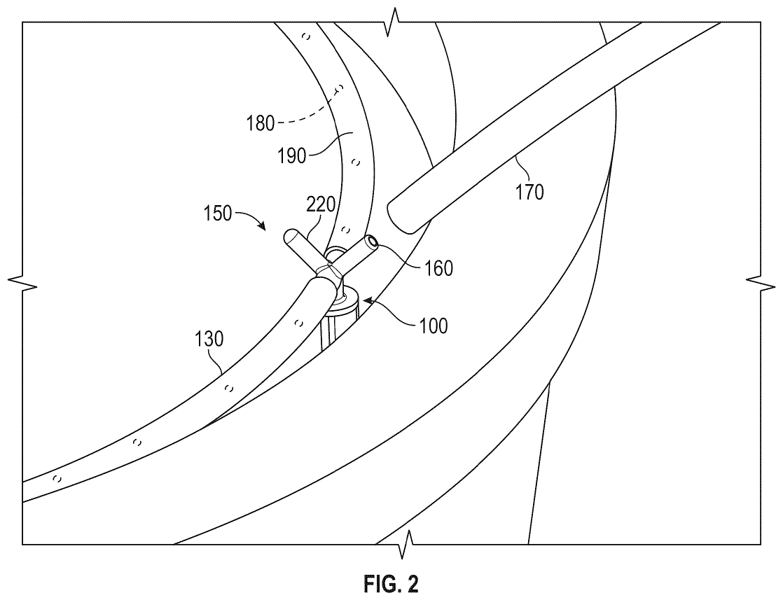

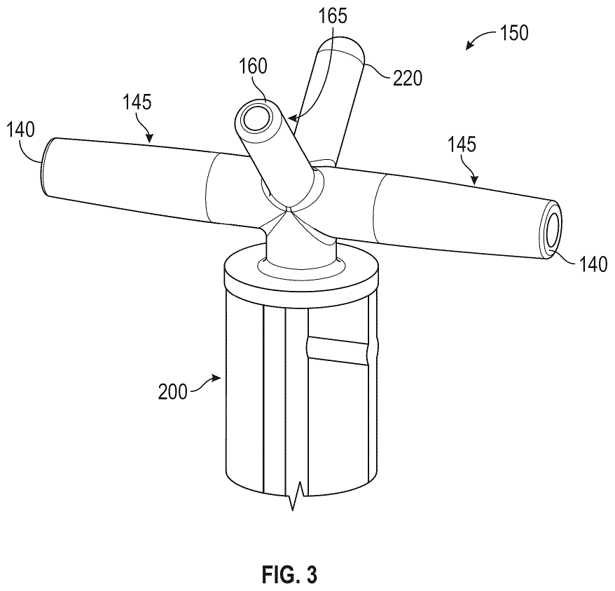

With reference to FIGS. 1-5, an embodiment of a tubing ring 100 for irrigating plants 110 in containers (e.g., pots) 120 in commercial nurseries will be described. The tubing ring 100 encircles the plant 110 and emits water from regularly spaced holes in its periphery, thereby distributing water uniformly throughout the container 120.

The tubing ring 100 includes a length of flexible tubing 130 connected to two 180-degree opposed output ports 140 of respective output nipples 145 of a rigid tee fitting/tee 150, with a supply port 160 of a supply nipple 165 being at 90 degrees to the two output ports 140 onto which a second length of tubing (“supply tubing”) 170 can be attached to supply water to the ring 100. The tubing 130 making up substantially all of the circular ring 100 has holes 180 through its walls 190 at regular spacing so that when water is supplied through the supply tubing 170 it emits from the periphery of the ring 100 at regular intervals.

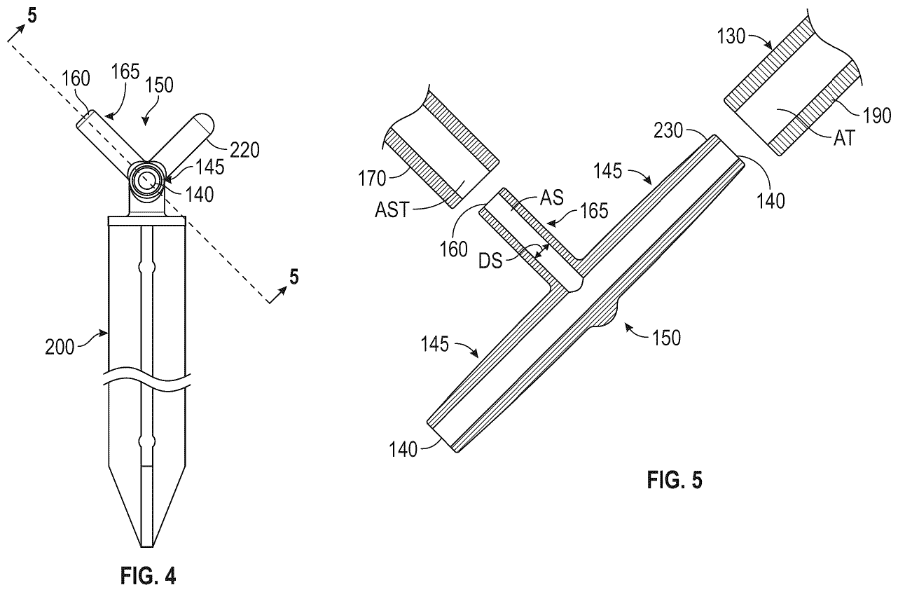

As shown in FIGS. 4 and 5, a cross-sectional area AS of an interior of the supply port 160 is significantly smaller than a cross-sectional area AT of the interior of the tubing 130, a cross-sectional area AST of the interior of the supply tubing 170 and the combined cross-sectional areas of the holes 180 in the periphery of the tubing ring 100. As a result, the total rate of water flow from the ring 100 and to the plant 110 is determined by the pressure of the water in the supply tubing 170 and the cross-sectional area AS of the interior of the supply port 160 and is not materially affected by the diameter of the tubing 130, the number of holes 180 along its periphery, or other factors. For a given supply pressure, the flow rate is determined by an internal diameter DS of the supply port 160. Total flow rate from the ring 100 is approximately proportional to the product of the cross-sectional area AS of the interior of the supply port 160 and the square root of the supply pressure.

In one or more embodiments or implementations of the above embodiment, the ring 100 and/or tubing 170 is rigid and/or flexible; the tee 150 and the ring 100/tubing 170 are a single piece with one supply port 160; the tee 150 includes a long rigid stake 200 attached to it, allowing the position of the tee 150 to be secured by soil 210 in the container 120; the tee 150 has a fourth solid port/nipple 220 through which water cannot flow, allowing the supply tubing 170 to be blocked by removing it from the supply port 160 and attaching it to the solid port 220 (e.g., done if the plant 110 were sold and water must be turned off); exterior surfaces 230 of the output ports 140 of the tee 150 are smooth and tapered so the tubing 170 can be easily removed in order to remove the ring 100 from the plant 110 when the plant 110 is sold; a kit or product line with a plurality of different flow rates at a nominal pressure (i.e., a plurality of models with different supply port inside diameters DS with different models easily differentiated using different standard colors, each color signifying a specific flow rate).

In use, the stake 200 attached to the tee 150 is inserted into the soil surrounding the plant 110 and the tubing 130 positioned to surround the plant 110 as shown in FIG. 1. The tubing 130 is attached to the two 180-degree opposed output nipples 145 of the tee 150 and the supply tubing 170 is attached to the supply nipple 165. Water is supplied to the ring 100 via the supply tubing 170 and supply port 160. Water is emitted from the ring 100 via the holes 180. The total rate of water flow from the ring 100 and to the plant 110 is determined by the pressure of the water in the supply tubing 170 and the cross-sectional area AS of the interior of the supply port 160 and, for a given supply pressure, the flow rate is determined by an internal diameter DS of the supply port 160. If the plant 110 is sold and water must be turned off, the supply tubing 170 is removed from the supply nipple 165 and attached to the solid nipple 220 to block water flow to the ring 100.

The figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in the following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

We claim:

1. A tee fitting for a tubing ring for irrigating a plant in a container, the tubing ring including tubing having a plurality of spaced holes configured to emit water, comprising:
one or more output ports configured to communicate with the tubing;
a supply port configured to communicate with supply tubing, the supply port having an internal diameter configured to determine, for a given water supply pressure, a flow rate of water emitted from the plurality of spaced holes of the tubing.

2. The tee fitting of claim 1, wherein the one or more output ports of the tee fitting include two 180-degree opposed output ports.

3. The tee fitting of claim 2, further including two 180-degree opposed output nipples terminating in the two 180-degree opposed output ports, and the two 180-degree opposed output nipples configured to receive the tubing for communication therewith.

4. The tee fitting of claim 1, further including a supply nipple terminating in the supply port, and the supply nipple configured to receive the supply tubing for communication therewith to supply water to the ring.

5. The tee fitting of claim 4, wherein the supply port includes an interior with a cross-sectional area.

6. The tee fitting of claim 5, further including the tubing, which includes an interior with a cross-sectional area, and the cross-sectional area of the interior of the supply port is less than the cross-sectional area of the interior of the tubing.

7. The tee fitting of claim 5, further including supply tubing in communication with the supply port to supply water to the ring, the supply tubing including an interior with a cross-sectional area, and the cross-sectional area of the interior of the supply port is less than the cross-sectional area of the interior of the supply tubing.

8. The tee fitting of claim 5, further including the tubing, which includes the plurality of spaced holes having combined cross-sectional areas, and the cross-sectional area of the interior of the supply port is less than the combined cross-sectional areas of the tubing.

9. The tee fitting of claim 1, wherein the tee is rigid and/or flexible.

10. The tee fitting of claim 1, further including the tubing and the tee and the tubing are a single piece.

11. The tee fitting of claim 1, wherein the tee includes a rigid stake configured to be secured into soil in the container.

12. The tee fitting of claim 1, wherein the tee includes a solid nipple through which water cannot flow, the solid nipple configured to receive supply tubing and function as a temporary holder of the supply tubing while blocking water flow from the supply tubing to the tee fitting.

13. The tee fitting of claim 1, wherein the tee is a member of a kit and/or product line of different flow-rate tees with different supply port interior diameters.

14. The tee fitting of claim 13, wherein the kit and/or product line of different flow-rate tees include different colors with each color signifying a specific flow rate.

15. A method of using the tee fitting of claim 1, comprising:
surrounding the plant of the container with the tubing;
attaching the tubing to the one or more output ports of the tee;
attaching supply tubing to the supply port of the tee;
supplying water to the tubing via the supply tubing and the supply port;
emitting water from the tubing to irrigate the plant via the plurality of spaced holes.

16. The method of claim 15, wherein the tee includes a solid nipple through which water cannot flow, the solid nipple configured to receive the supply tubing and function as a temporary holder of the supply tubing while blocking water flow from the supply tubing to the tubing ring, and the method further comprising detaching the supply tubing from the supply port and attaching the supply tubing to the solid nipple so as to temporary hold the supply tubing while blocking water flow from the supply tubing to the tubing ring.

17. The method of claim 15, wherein the tee is a member of a kit and/or product line of different flow-rate tees with different supply port interior diameters, and the method further comprising:
surrounding a different plant of a different container with different tubing;
attaching the different tubing to the one or more output ports of a different flow-rate tee of the kit and/or product line;
attaching different supply tubing to the supply port of the different flow-rate tee;
supplying water to the different tubing via the different supply tubing and the supply port of the different flow-rate tee;
emitting water from the different tubing at a different flow rate to irrigate the different plant via the plurality of spaced holes of the different tubing.
